(19) United States
(12) Patent Application Publication
(10) Pub. No.: US 2010/0085860 A1
(43) Pub. Date: Apr. 8, 2010

(54) OPTICAL HEAD DEVICE, AND OPTICAL INFORMATION RECORDING/REPRODUCING DEVICE AND OPTICAL INFORMATION RECORDING/REPRODUCING METHOD USING THE SAME

(76) Inventor: Ryuichi Katayama, Tokyo (JP)

Correspondence Address: Mr. Jackson Chen, 6535 N. STATE HWY 161, IRVING, TX, 75039, US

(21) Appl. No.: 12/593,411

(22) PCT Filed: Mar. 4, 2008
(86) PCT No.: PCT/JP2008/053835

§ 371 Date: Dec. 7, 2009

(30) Foreign Application Priority Data
Mar. 28, 2007 (JP) 2007-085276

(51) Int. Cl. G11B 7/135

(52) U.S. Cl. 369/112.16; G9B/7.112

(57) ABSTRACT

Light outputted from a semiconductor laser (1) passes through a liquid crystal diffraction optical element (2a) as 0-order light and is collected to a disc (5). Reflection light from the disc (5) is diffracted by the liquid crystal diffraction optical element (2a) as ±primary diffracted light and received by optical detectors (6a, 6b). When information is being recorded on the disc (5), light entered the liquid crystal diffraction optical element (2a) from the side of the semiconductor laser (1) is outputted to the side of an objective lens (4) from the liquid crystal diffraction optical element (2a) at a high efficiency. When information is being reproduced from the disc (5), the liquid crystal diffraction optical element (2a) is driven so that light entered the liquid crystal diffraction optical element (2a) from the side of the objective lens (4) is outputted to the side of the optical detectors (6a, 6b) from the liquid crystal diffraction optical element (2a) at a high efficiency without depending on the polarization state.

### TECHNICAL FIELD

The present invention relates to an optical head device whose target is an optical recording medium on which information is recorded/reproduced by a difference in the reflectivity between a mark region and a space region, and an optical information recording/reproducing device and optical information recording/reproducing method using the optical head device. The present application claims priority based on Japanese patent application No. 2007-85276. The disclosed content in the Japanese patent application No. 2007-85276 is incorporated herein by this reference.

### BACKGROUND ART

There are optical recording media such as the CD-R (Compact Disc-Recordable), CD-RW (CD-ReWritable), DVD-R (Digital Versatile Disc-R), and DVD-RW, in which information is recorded/reproduced by the difference in the reflectivity between a mark region and a space region. The optical head device for performing recording/reproducing on an optical recording medium has a light separation part that separates a light emitted from a light source and a reflected light from the optical recording medium.

In a case where recording/reproducing of information is performed by the difference of the reflectivity between a mark region and a space region on the target medium of the optical system, the optical system is classified into a polarization optical system and a non-polarization optical system regarding the characteristics of the light separation part.

In the polarization optical system, the light separation part has characteristics of outputting linear polarized light, which is light incident from a light source side, and of which the polarization direction is parallel to a specified direction, to an objective lens side with high efficiency. The light separation part of the polarization optical system also has characteristics of outputting linear polarized light, which is light incident from the objective lens side, and of which the polarization direction is vertical to the specified direction, to an optical detector side with high efficiency.

On the other hand, in the non-polarization optical system, the light separation part has characteristics of outputting light incident from a light source side to an objective lens side with a predetermined efficiency without substantially depending on the polarization state of the light. The light separation part of the non-polarization optical system also has characteristics of outputting a light incident from the objective lens side to an optical detector side with a predetermined efficiency without substantially depending on the polarization state of the light.

As the light separation part, for example, a diffraction optical element is used. A diffraction optical element transmits light incident from a light source side to output it to an objective lens side, and also diffracts light incident from the objective lens side to output it to an optical detector side. FIG. 1 illustrates an example of a conventional optical head device whose target is an optical recording medium on which information is recorded/reproduced by the difference in the reflectivity between a mark region and a space region, and uses a diffraction optical element as the light separation part. The emitted light from a semiconductor laser 22 serving as a light source is incident on the diffraction optical element 23 serving as the light separation part; transmits through the diffraction optical element 23 as 0-th order light; transmits through a ¼ wavelength plate 24; is converted from a diverging light to a converging light by an objective lens 25; and is focused on a disk 26 serving as the optical recording medium. Also, reflected light from the disk 26 is converted from a diverging light to a converging light by the objective lens 25; transmits through the ¼ wavelength plate 24; is incident on the diffraction optical element 23; and is diffracted as ±1st order diffracted light by the diffraction optical element 23, which are received by optical detectors 27a and 27b.

In a case where the optical head device illustrated in FIG. 1 is a polarization optical system, a diffraction optical element, in which the efficiency depends on the polarization state of the incident light, is used as the diffraction optical element 23. This diffraction optical element, for example, transmits almost 100% of the linear polarized light serving as incident light of which the polarization direction is parallel to a specified direction as 0-th order light, and also diffracts approximately 81% of linear polarized light serving as incident light of which the polarization direction is vertical to the specified direction as ±1st order diffracted light. The light emitted from the semiconductor laser 22 is incident on the diffraction optical element 23 as the linear polarized light of which the polarization direction is parallel to a specified direction and almost 100% of the light transmits it as the 0-th order light to travel to the disk 26. Also, by the function of the ¼ wavelength plate 24, the reflected light from the disk 26 is incident on the diffraction optical element 23 as a linear polarized light of which the polarization direction is vertical to a specified direction, and as the ±1st order diffracted light, approximately 40.5% of the reflected light are respectively diffracted to travel to the optical detectors 27a and 27b.

On the other hand, in a case where the optical head device illustrated in FIG. 1 is a non-polarization optical system, a diffraction optical element whose efficiency does not depend on the polarization state of incident light is used as the diffraction optical element 23. This diffraction optical element, for example, transmits approximately 50% of incident light as the 0-th light independently of the polarization state of the light, and also diffracts approximately 40.5% of the incident light as ±1st order diffracted light independently of the polarization state of the light. The emitted light from the semiconductor laser 22 is incident on the diffraction optical element 23, and approximately 50% of the light transmits it as the 0-th order light to travel to the disk 26. Also, the reflected light from the disk 26 is incident on the diffraction optical element 23, and as the ±1st order diffracted light, approximately 20.3% of the reflected light is respectively diffracted to travel to the optical detectors 27a and 27b.

In the optical head device illustrated in FIG. 1, the characteristics of the diffraction optical element 23 serving as the light separation part are the same between the information recording on the disk 26 serving as the optical recording medium, and the information reproducing from the disk 26 serving as the optical recording medium. On the other hand, in Japanese Laid-Open Patent Application JP-A-Heisei 5, 109111, an optical head device is described, in which characteristics of a light separation part are switched between the information recording on an optical recording medium and the information reproducing from the optical recording medium. The target medium of this optical head device is an optical recording medium in which information is recorded/reproduced based on the difference in magnetization direction between a mark region and a space region like an optical magnetic disk.

FIG. 2 illustrates a configuration of the optical head device described in Japanese Laid-Open Patent Application JP-A-Heisei, 5-109111. Emitted light from a semiconductor laser 22 serving as a light source is incident on a liquid crystal diffraction optical element 28 serving as a light separation part; transmits through the liquid crystal diffraction optical element 28 as 0-th order light; transmits a Faraday rotator 29; is converted from a diverging light to a converging light by an objective lens 25, and is focused on a disk 26 serving as the optical recording medium 26. Also, reflected light from the disk 26 is converted from a diverging light to a converging light by the objective lens 25; transmits through the Faraday rotator 29; is incident on the liquid crystal diffraction optical element 28; and is diffracted as ±1st order diffracted light by the liquid crystal diffraction optical element 28, which are received by optical detectors 27a and 27b.

FIG. 3 is a cross-sectional view of the liquid crystal diffraction optical element 28. The liquid crystal diffraction optical element 28 has a configuration in which a liquid crystal polymer layer 32 is sandwiched between substrates 30a and 30b. A surface of the substrate 30a on the liquid crystal polymer 32 side, and a surface of the substrate 30b on the liquid crystal polymer 32 side are formed with electrodes 31a and 31b for applying an AC voltage to the liquid crystal polymer layer 32, respectively. The electrode 31a is an entire surface electrode, and the electrode 31b is a pattern electrode forming a diffractive grating.

Upon recording information on the disk 26, the liquid crystal polymer layer 32 is applied with an AC voltage of approximately 3 V. In this time, the liquid crystal diffraction optical element 28 hardly diffracts linear polarized light of which the polarization direction is parallel to the plane of the sheet, and diffracts more than 30% of linear polarized light of which the polarization direction is vertical to the plane of the sheet as the ±1st order diffracted light. On the other hand, upon reproduction information from the disk 26, the liquid crystal polymer layer 32 is applied with an AC voltage of approximately 6 V. In this time, the liquid crystal diffraction optical element 28 diffracts more than 40% of linear polarized light of which the polarization direction is parallel to the plane of the sheet as the ±1st order diffracted light, and diffracts approximately 20% of linear polarized light of which the polarization direction is vertical to the plane of the sheet as the ±1st order diffracted light.

Also, Japanese Laid-Open Patent Application JP-P2001-319367A describes an information recording/reproducing device including a polarization plane control part and a diffraction part in an optical system. Upon recording, the information recording/reproducing device modulates laser beam emitted from a light source in accordance with an information signal, and then irradiates an optical recording medium with it through the optical system to record the information signal. Upon reproduction, the information recording/reproducing device irradiates the optical recording medium with the laser beam, which is emitted from the light source and has a constant intensity, through the optical system, and detects reflected light from the optical recording medium through the optical system to reproduce a recorded information signal. The polarization plane control part controls the polarization plane of the laser beam emitted from the light source such that the polarization plane upon reproduction and that upon recording are orthogonal to each other. On the diffraction part, the laser beam of which the polarization plane is controlled by the polarization plane control part is incident. Upon reproduction, the diffraction part diffracts the laser beam having a specified polarization plane to thereby extract the total of three laser beams of which the main beam is irradiated on any of the main track of the optical recording medium, and two sub-beams are independently irradiated on two adjacent tracks that are adjacent to both sides of the main track, or between the main track and the adjacent tracks, and irradiate the optical recording medium. Upon recording, the diffraction part irradiates the optical recording medium with one recording laser beam.

Further, In Japanese Laid-Open Patent Application JP-P2002-260272A, an optical head device is described, which includes a light source, a light focusing part, a light separation part, an optical detection part, and an optical coupling efficiency variable part. The light source emits an optical beam, and the light focusing part supplies the optical beam from the light source to an optical recording medium. The light separation part separates the light beam emitted from the light source and a reflected beam from the optical recording medium. The optical detection part receives the reflected beam from the optical recording medium, which is separated by the light separation part. The optical coupling efficiency variable part; which can vary the optical coupling efficiency that is the ratio of the amount of the beam focused on the optical recording medium to the total light amount of the optical beam emitted from the light source, is provided between the light source and the light separation part.

The optical recording medium has a protection layer, for which the polycarbonate is typically used as a low-cost material. However, the polycarbonate has birefringence. The protection layer of the optical recording medium typically has biaxial refractive index anisotropy. Assuming that three main axes are the X-axis, the Y-axis and the Z-axis, XYZ coordinate can be determined such that the X- and Y-axes are vertical to the normal direction of the optical recording medium, and the Z-axis is parallel to the normal direction of the optical recording medium. Assuming that three principal refractive indices corresponding to the three main axes are denoted by nx, ny, and nz, the values of in-plane birefringence and vertical birefringence can be respectively defined as Δni=nx−ny, and Δnv=(nx+ny)/2−nz.

In an optical head device whose target is an optical recording medium in which information is recorded/reproduced based on the difference in reflectivity between a mark region and a space region, in a case where an optical system of the optical head device is configured to be the polarization optical system, light incident on a light separation part from a light source side is outputted to an objective lens side from the light separation part with high efficiency, so that the amount of the outputted light from the objective lens upon recording is large, and therefore a high optical output can be obtained upon recording. Also, if the protection layer of an optical recording medium has no birefringence, light incident on the light separation part from the objective lens side is outputted to an optical detector side from the light separation part with high efficiency, so that the amount of the received light in the optical detector upon reproduction is large, and therefore a high signal-to-noise ratio can be obtained upon reproduction. However, if the protection layer of the optical recording medium has in-plane or vertical birefringence, efficiency at the time when the light incident on the light separation part from the objective lens side is outputted to the optical detector side from the light separation part is reduced, so that the amount of the received light in the optical detector upon reproduction is reduced, and therefore the signal-to-noise ratio obtained upon reproduction is reduced.

FIG. 4 illustrates a calculation example of the relationship between the value of in-plane birefringence of a protection layer of an optical recording medium and the amount of received light in an optical detector for the case where the wavelength of a light source is 405 nm, and the thickness of the protection layer of the optical recording medium is 0.6 mm. The vertical axis of the diagram represents the relative amount of received light which is normalized with the amount of received light for the case where the value of in-plane birefringence is zero. It turns out that as the absolute value of the value of in-plane birefringence increases, the relative amount of received light is decreased, and the relative amount of received light for the case where the absolute value of the value of in-plane birefringence is 1×10⁻⁴ is 0.4 or less.

On the other hand, in a case where, in the optical head device whose target is an optical recording medium in which information is recorded/reproduced based on the difference in the reflectivity between a mark region and a space region, an optical system is configured to be the non-polarization optical system, even if a protection layer of the optical recording medium has in-plane or vertical birefringence, the efficiency at the time when the light incident on the light separation part from the objective lens side is outputted to the optical detector side from the light separation part is unchanged. For this reason, the amount of the received light in the optical detector upon reproduction does not vary, and therefore the signal-to-noise ration obtained upon reproduction is unchanged. However, if the efficiency at the time when light incident on the light separation part from a light source side is outputted to the objective lens side from the light separation part is designed to be higher, the amount of outputted light from the objective lens upon recording is large, and therefore a high optical output can be obtained upon recording; however, the efficiency at the time when the light incident on the light separation part from the objective lens side is outputted to the optical detector side from the light separation part is decreased. For this reason, the amount of the received light in the optical detector upon reproduction is decreased, and therefore the signal-to-noise ratio obtained upon reproduction is decreased. Also, if the efficiency at the time when the light incident on the light separation part from the objective lens side is outputted to the optical detector side from the light separation part is designed to be higher, the amount of the received light in the optical detector upon reproduction is large, and therefore a high signal-to-noise ratio can be obtained upon reproduction; however, the efficiency at the time when the light incident on the light separation part from the light source is outputted to the objective lens side from the light separation part is decreased. For this reason, the amount of the outputted light from the objective lens upon recording is decreased, and the optical output obtained upon recording is reduced. That is, the optical output obtained upon recording and the signal-to-noise ratio obtained upon reproduction are incompatible.

Further, the optical head device illustrated in FIG. 2 is one whose target is an optical recording medium in which information is recorded/reproduced based on the difference in the magnetization direction between a mark region and a space region. In a case where this optical head device is applied to the optical recording medium in which information is recorded/reproduced on the basis of the difference in reflectivity between a mark region and a space region, the efficiency at the time when light incident on the light separation part from the light source side upon recording is outputted to the objective lens side from the light separation part is high, so that the amount of outputted light from the objective lens upon recording is large, and therefore the optical output obtained upon recording is high. However, the efficiency at the time when light incident on the light separation part from the objective lens side upon reproduction is outputted to the optical detector side from the light separation part is low, so that the amount of received light in the optical detector upon reproduction is small, and therefore the signal-to-noise ratio obtained upon reproduction is low.

### DISCLOSURE OF INVENTION

An object of the present invention is to provide an optical head device capable of obtaining a high optical output upon recording of information on an optical recording medium, and also obtaining a high signal-to-noise ratio upon reproduction of information from the optical recording medium even if a protection layer of the optical recording medium has birefringence, and an optical information recording/reproducing device and an optical information recording/reproducing method using the optical head device.

In an aspect of the present invention, an optical head device includes an objective lens, an optical detector, and a light separation part. The objective lens focuses an emission light emitted from a light source on an optical recording medium on which information is recorded and from which information is reproduced based on a difference in a reflectivity between a mark region and a space region. The optical detector receives a reflection light reflected by the optical recording medium. The light separation part separates the emission light and the reflection light. We here define a ratio of an amount of light of a light emitted from the light separation part toward the objective lens side to an amount of a light incident on the light separation part from the light source side is a ratio of an outward path, and a ratio of an amount of light of a light emitted from the light separation part toward the optical detector side to an amount of light of a light incident on the light separation part from the objective lens side is a return path ratio. The light separation part is able to switch its characteristic between a first state in which the ratio of the outward path is a first value, and a second state in which the ratio of the outward path is a second value smaller than the first value. When the characteristic of the light separation part is at the second state, the ratio of the return path is substantially determined independently to the polarization state of a light incident on the light separation part from the objective lens side.

In another aspect of the present invention, an optical information recording/reproducing method is one for recording and reproducing information by an optical information recording/reproducing device including the above-described optical head device and a drive circuit to drive the light separation part. The light separation part is driven by the drive circuit to set the characteristic of the light separation part to the first state when information is recorded on the optical recording medium, and the light separation part is driven by the drive circuit to set the characteristic of the light separation part to the second state when information is reproduced from the optical recording medium.

In still another aspect of the present invention, an optical information recording/reproducing method includes a step of focusing a light, a step of receiving a light and a step of separating. In the step of focusing a light, an emission light emitted from a light source is focused on an optical recording medium on which information is recorded and from which information is reproduced based on a difference in a reflectivity between a mark region and a space region by an objective lens. In the step of receiving a light, a light reflected by the optical recording medium is received by an optical detector. In the step of separating, the emission light and the reflection light are separated by the light separation part. The step of separating includes: a first separation step for recording information on the optical recording medium; and a second separation step for reproducing information from the optical recording medium. In the first separation step, the emission light and the reflection light are separated with a ratio of the outward path being set to a first value. In the second separation step, the emission light and the reflection light are separated with the ratio of the outward path being set to a second value smaller than the first value. Note that the ratio of the outward path refers to a ratio of an amount of a light emitted from the light separation part toward the objective lens side to an amount of a light incident on the light separation part from the light source side. A return path ratio refers to a ratio of a light emitted from the light separation part toward the optical detector side to an amount of a light incident on the light separation part from the objective lens side. The return path ratio is determined without substantially depending on the polarization state of the light incident on the light separator part from the objective lens side.

According to the present invention, in an optical head device, and an optical information recording/reproducing device and an optical information recording/reproducing method using the optical head device, characteristics of the light separation part are configured such that, upon recording of information on an optical recording medium, light incident on the light separation part from the light source side is outputted to the objective lens side from the light separation part with high efficiency. In this case, the amount of an outputted light from the objective lens upon recording is large, and therefore a high optical output can be obtained upon recording. On the other hand, upon reproduction of information from the optical recording medium, the characteristics of the light separation part are configured such that light incident on the light separation part from the objective lens side is outputted to the optical detector side from the light separation part with high efficiency without substantially depending on the polarization state of the light. In this case, if the protection layer of the optical recording medium has no birefringence, the amount of received light in the optical detector upon reproduction is large, and therefore a high signal-to-noise ratio can be obtained upon reproduction. Also, even if the protection layer of the optical recording medium has in-plane or vertical birefringence, the amount of the received light in the optical detector upon reproduction is unchanged, and therefore the signal-to-noise ratio obtained upon reproduction is unchanged. That is, even if the protection layer of the optical recording medium has some birefringence, a high signal-to-noise ratio can be obtained upon reproduction.

### BRIEF DESCRIPTION OF DRAWINGS

The above-described object, effects, and features of the present invention will be more clarified from description of embodiments in collaboration with the accompanying drawings, in which:

FIG. 1 is a diagram illustrating a configuration example of a conventional optical head device (light separation part: diffraction optical element);

FIG. 2 is a diagram illustrating a configuration example of a conventional optical head device (switching of characteristics of light separation part);

FIG. 3 is a cross-sectional view of a liquid crystal diffraction optical element of the conventional optical head device;

FIG. 4 is a diagram illustrating an example of calculation of a relationship between a value of in-plane birefringence of a protection layer of an optical recording medium and an amount of received light in an optical detector;

FIG. 5 is a diagram illustrating a configuration of an optical head device according to a first embodiment of the present invention;

FIGS. 6A and 6B are cross-sectional views of a liquid crystal diffraction optical element of the optical head device according to the first embodiment of the present invention;

FIGS. 7A and 7B are cross-sectional views of a liquid crystal diffraction optical element of an optical head device according to a second embodiment of the present invention;

FIGS. 8A and 8B are cross-sectional views of a liquid crystal diffraction optical element of an optical head device according to a third embodiment of the present invention;

FIGS. 9A and 9B are diagrams illustrating light receiving parts of the optical detectors of the optical head device according to the first to third embodiments of the present invention and optical spots formed on light receiving parts; and

FIG. 10 is a diagram illustrating a configuration of an optical information recording/reproducing device according to a fourth embodiment of the present invention.

### BEST MODE FOR CARRYING OUT THE INVENTION

Embodiments of the present invention will hereinafter be described referring to the drawings.

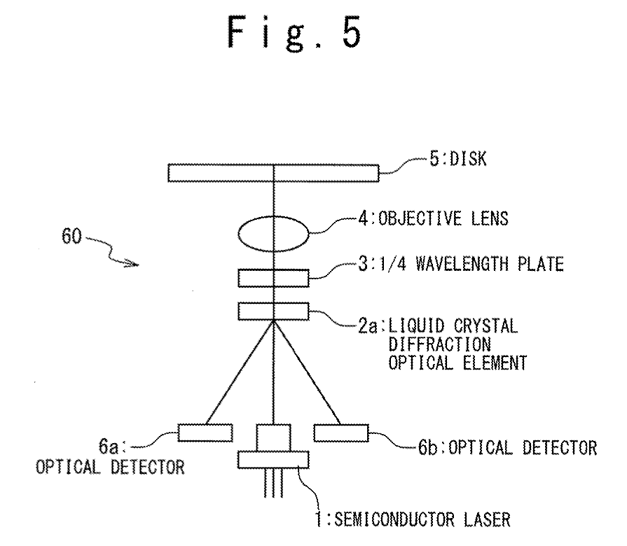

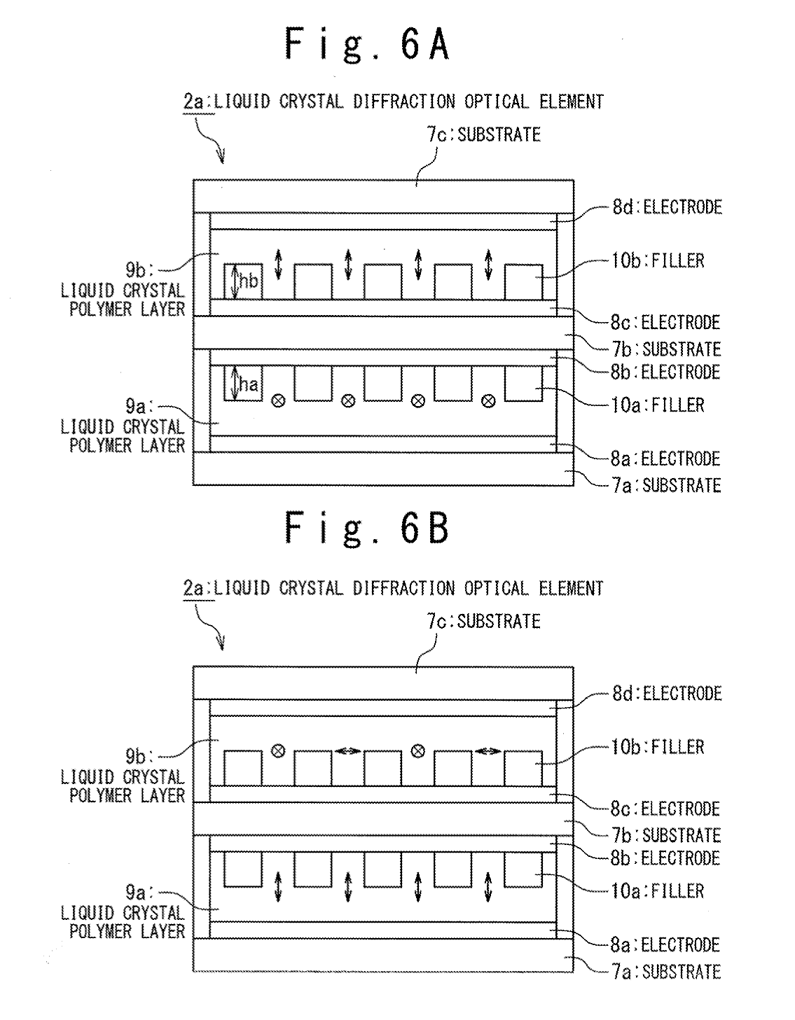

FIG. 5 illustrates a configuration of an optical head device according to a first embodiment of the present invention. An optical head device 60 includes a semiconductor laser 1, a liquid crystal diffraction optical element 2a, a ¼ wavelength plate 3, an objective lens 4, and optical detectors 6a and 6b. Emitted light from the semiconductor laser 1 serving as a light source is incident on the liquid crystal diffraction optical element 2a serving as a light separation part; transmits through the liquid crystal diffraction optical element 2a as 0-th order light; transmits through the ¼ wavelength plate 3; is converted from a diverging light to a converging light by the objective lens 4; and is focused on a disk 5 serving as an optical recording medium. Also, reflected light from the disk 5 is converted from a diverging light to a converging light by the objective lens 4; transmits through the ¼ wavelength plate 3; is incident on the liquid crystal diffraction optical element 2a; and is diffracted by the liquid crystal diffraction optical element 2a as ±1st order diffracted light, which are then received by the optical detectors 6a and 6b. FIGS. 6A and 6B are cross-sectional views of the liquid crystal diffraction optical element 2a. The liquid crystal diffraction optical element 2a has a configuration in which a liquid crystal polymer layer 9a and a filler 10a are sandwiched between substrates 7a and 7b, and a liquid crystal polymer layer 9b and a filler 10b are sandwiched between the substrates 7b and a substrate 7c. On a surface of the substrate 7a on the liquid crystal polymer layer 9a side and a surface of the substrate 7b on the liquid crystal polymer layer 9a side, electrodes 8a and 8b for applying an AC voltage to the liquid crystal polymer layer 9a are formed, respectively. Also, on a surface of the substrate 7b on the liquid crystal polymer layer 9b side and a surface of the substrate 7c on the liquid crystal polymer layer 9b side, electrodes 8c and 8d for applying the AC voltage to the liquid crystal polymer layer 9b are formed, respectively. The electrodes 8a to 8d are all entire surface electrodes. The arrows in the diagrams indicate the longer direction of the liquid crystal polymers in the liquid crystal polymer layers 9a and 9b. Any of the liquid crystal polymer layers 9a and 9b has uniaxial refractive index anisotropy in which the direction of the optical axis corresponds to the longer direction of the liquid crystal polymers. Assuming that the refractive index for a polarization component (extraordinary light component) in the direction parallel to the longer direction of the liquid crystal polymers is denoted by ne, and that for a polarization component (ordinary light component) in the direction vertical to the longer direction by no, ne is large as compared with no. Also, refractive indices of the fillers 10a and 10b are both no. Any of the fillers 10a and 10b forms a diffractive grating having a rectangular cross-sectional shape of which widths of a line region and a space region are the same. We here denote depths of the diffraction gratings formed by the fillers 10a and 10b as ha and hb, respectively.

In a case where the effective value of an AC voltage applied to the liquid crystal polymer layer 9a is set to 0 V, and that of the AC voltage applied to the liquid crystal polymer layer 9b is set to 5 V, the longer direction of the liquid crystal polymers in the liquid crystal polymer layer 9a corresponds to the direction vertical to the optical axis of incident light and to the plane of the sheet on which the diagram is drawn, and that of the liquid crystal polymers in the liquid crystal polymer layer 9b corresponds to the direction parallel to the optical axis of the incident light, as illustrated in FIG. 6A. Accordingly, if the incident light is linear polarized light of which the polarization direction is parallel to the plane of the diagram, refractive indices of the liquid crystal polymer layers 9a and 9b for the incident light become no and no, respectively. For this reason, neither the diffraction grating formed by the filler 10a nor that formed by the filler 10b has any diffractive action. Also, if the incident light is linear polarized light of which the polarization direction is vertical to the plane of the diagram, the refractive indices of the liquid crystal polymer layers 9a and 9b for the incident light become ne and no, respectively. For this reason, the diffraction grating formed by the filler 10a has a diffractive action, whereas that formed by the filler 10b has no diffractive action. Note that, if ha is determined so as to meet ha=0.5λ/(ne−no) (λ is the wavelength of the incident light), the transmittance of 0-th order light and each of diffraction efficiencies of ±1st order diffracted light in the diffraction grating formed by the filler 10a become 0%, and 40.5%, respectively.

On the other hand, in a case where the effective value of an AC voltage applied to the liquid crystal polymer layer 9a is set to 5 V, and that of the AC voltage applied to the liquid crystal polymer layer 9b is set to 0 V, the longer direction of the liquid crystal polymers in the liquid crystal polymer layer 9a corresponds to the direction parallel to the optical axis of the incident light, and that of the liquid crystal polymers in the liquid crystal polymer layer 9b corresponds to the direction that is vertical to the optical axis of the incident light and random for each of the liquid crystal polymers, as illustrated in FIG. 6B. Accordingly, without depending on the polarization state of the incident light, the refractive indices of the liquid crystal polymer layers 9a and 9b for the incident light become no, and [(2no²+ne²)/3]^{1/2}, respectively. For this reason, the diffraction grating formed by the filler 10b has the diffractive action, whereas that formed by the filler 10a has no diffractive action. Note that, if, given that nr=[(2no²+ne²)/3]^{1/2}, hb is determined so as to meet hb=0.398λ/(nr−no) (λ is the wavelength of the incident light), the transmittance of 0-th order light and each of diffraction efficiencies of ±1st order diffracted light in the diffraction grating formed by the filler 10b become 10%, and 36.5%, respectively.

Upon recording of information on the disk 5, the effective value of an AC voltage applied to the liquid crystal polymer layer 9a is set to 0 V, and that of the AC voltage applied to the liquid crystal polymer layer 9b is set to 5 V. In this case, the emitted light from the semiconductor laser 1 is incident on the liquid crystal diffraction optical element 2a as the linear polarized light of which the polarization direction is parallel to the plane of the sheet, and almost 100% of the light transmits it as the 0-th order light to travel to the disk 5. Also, if the protection layer of the disk 5 has no birefringence, due to the function of the ¼ wavelength plate 3, the reflected light from the disk 5 is incident on the liquid crystal diffraction optical element 2a as the linear polarized light of which the polarization direction is vertical to the plane of the diagram, and as the ±1st order diffracted light, approximately 40.5% of the reflected light are diffracted to travel to the optical detectors 6a and 6b, respectively. As a result, the light incident on the liquid crystal diffraction optical element 2a from the semiconductor laser 1 side is outputted to the objective lens 4 side from the liquid crystal diffraction optical element 2a with high efficiency, so that the amount of outputted light from the objective lens 4 upon recording is large, and therefore a high optical output can be obtained upon recording.

On the other hand, upon reproduction of information from the disk 5, the effective value of an AC voltage applied to the liquid crystal polymer layer 9a is set to 5 V, and that of the AC voltage applied to the liquid crystal polymer layer 9b is set to 0 V. In this case, the emitted light from the semiconductor laser 1 is incident on the liquid crystal diffraction optical element 2a, and without depending on the polarization state of the light, approximately 10% of the light transmits it as the 0-th order light to travel to the disk 5. Also, the reflected light from the disk 5 is incident on the liquid crystal diffraction optical element 2a, and without depending on the polarization state of the reflected light, as the ±1st order diffracted light, approximately 36.5% of the reflected light are diffracted to travel to the optical detectors 6a and 6b, respectively. As a result, the light incident on the liquid crystal diffraction optical element 2a from the objective lens 4 side is outputted to the optical detectors 6a and 6b sides from the liquid crystal diffraction optical element 2a with high efficiency without depending on the polarization state of the light. For this reason, if the protection layer of the disk 5 has no birefringence, the total amount of received light in the optical detectors 6a and 6b upon reproduction is large, and therefore a high signal-to-noise ratio can be obtained upon reproduction. Also, even if the protection layer of the disk 5 has in-plane or vertical birefringence, the total amount of the received light in the optical detectors 6a and 6b upon reproduction is unchanged, and therefore the signal-to-noise ratio obtained upon reproduction is unchanged. That is, even if the protection layer of the disk 5 has some birefringence, a high signal-to-noise ratio can be obtained upon reproduction.

A second embodiment of the optical head device of the present invention is one in which the liquid crystal diffraction optical element 2a in the first embodiment is replaced by a liquid crystal diffraction optical element 2b, and a configuration of the second embodiment is the same as that illustrated in FIG. 5.

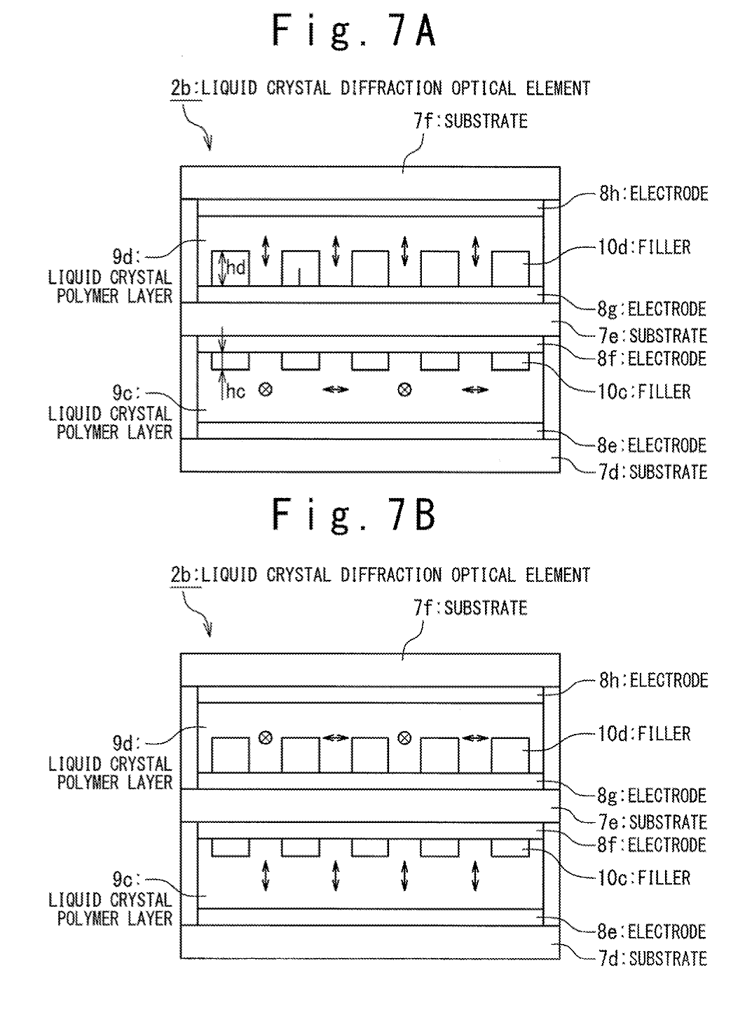

FIGS. 7A and 7B are cross-sectional views of the liquid crystal diffraction optical element 2b. The liquid crystal diffraction optical element 2b has a configuration in which a liquid crystal polymer layer 9c and a filler 10c are sandwiched between substrates 7d and 7e, and a liquid crystal polymer layer 9d and a filler 10d are sandwiched between the substrate 7e and a substrate 7f. On a surface of the substrate 7d on the liquid crystal polymer layer 9c side and a surface of the substrate 7e on the liquid crystal polymer layer 9c side, electrodes 8e and 8f for applying an AC voltage to the liquid crystal polymer layer 9c are formed, respectively. Also, on a surface of the substrates 7e on the liquid crystal polymer layer 9d side and a surface of the substrates 7f on the liquid crystal polymer layer 9d side, electrodes 8g and 8h for applying the AC voltage to the liquid crystal polymer layer 9d are formed, respectively. The electrodes 3e to 8h are all entire surface electrodes. The arrows in the diagrams indicate the longer direction of liquid crystal polymers in the liquid crystal polymer layers 9c and 9d. Any of the liquid crystal polymer layers 9c and 9d has uniaxial refractive index anisotropy in which the direction of the optical axis corresponds to the longer direction of the liquid crystal polymers. Assuming that the refractive index for a polarization component (extraordinary light component) in the direction parallel to the longer direction of the liquid crystal polymers is denoted by ne, and that for a polarization component (ordinary light component) in the direction vertical to the longer direction by no, ne is large as compared with no. Also, the refractive indices of the fillers 10c and 10d are both no. Any of the fillers 10c and 10d forms a diffractive grating having a rectangular cross-sectional shape of which widths of a line region and space region are the same. We here denote the depths of the diffraction gratings formed by the fillers 10c and 10d as he and hd, respectively.

In a case where the effective value of an AC voltage applied to the liquid crystal polymer layer 9c is set to 0 V, and that of the AC voltage applied to the liquid crystal polymer layer 9d is set to 5 V, the longer direction of the liquid crystal polymers in the liquid crystal polymer layer 9c corresponds to the direction that is vertical to the optical axis of incident light and random for each of the liquid crystal polymers, and that of the liquid crystal polymers in the liquid crystal polymer layer 9d corresponds to the direction parallel to the optical axis of the incident light, as illustrated in FIG. 7A. Accordingly, without depending on the polarization state of the incident light, refractive indices of the liquid crystal polymer layers 9c and 9d for the incident light become [(2no²+ne²)/3]^{1/2}, and no, respectively. For this reason the diffraction grating formed by the filler 10c has a diffractive action, whereas that formed by the filler 10d has no diffractive action. If, given that nr=[(2no²+ne²)/3]^{1/2}, hc is determined so as to meet hc=0.102λ/(nr−no) (λ is the wavelength of the incident light), the transmittance of the 0-th order light, and each of diffraction efficiencies of ±1st order diffracted light in the diffraction grating formed by the filler 10c are 90% and 4.1%, respectively.

On the other hand, in a case where the effective value of an AC voltage applied to the liquid crystal polymer layer 9c is set to 5 V, and that of the AC voltage applied to the liquid crystal polymer layer 9d is set to 0 V, the longer direction of the liquid crystal polymers in the liquid crystal polymer layer 9c corresponds to the direction parallel to the optical axis of the incident light, and that of the liquid crystal polymers in the liquid crystal polymer layer 9d corresponds to the direction that is vertical to the optical axis of the incident light and random for each of the liquid crystal polymers, as illustrated in FIG. 7B. Accordingly, without depending on the polarization state of the incident light, the refractive indices of the liquid crystal polymer layers 9c and 9d for the incident light become no, and [(2no²+ne²)/3]^{1/2}, respectively. For this reason, the diffraction grating formed by the filler 10d has the diffractive action, whereas that formed by the filler 10c has no diffractive action. Note that, if, given that nr=[(2no²+ne²)/3]^{1/2}, hd is determined so as to meet hd=0.398λ/(nr−no) (λ is the wavelength of the incident light), the transmittance of the 0-th order light and each of diffraction efficiencies of ±1st order diffracted light in the diffraction grating formed by the filler 10d become 10%, and 36.5%, respectively.

Upon recording of information on the disk 5, the effective value of an AC voltage applied to the liquid crystal polymer layer 9c is set to 0 V, and that of the AC voltage applied to the liquid crystal polymer layer 9d is set to 5 V. In this case, the emitted light from the semiconductor laser 1 is incident on the liquid crystal diffraction optical element 2b, and without depending on the polarization state of the light, approximately 90% of the light transmits it as the 0-th order light to travel to the disk 5. Also, the reflected light from the disk 5 is incident on the liquid crystal diffraction optical element 2b, and without depending on the polarization state of the reflected light, as the ±1st order diffracted light, approximately 4.1% of the reflected light is diffracted to travel to the optical detectors 6a and 6b, respectively. As a result, the light incident on the liquid crystal diffraction optical element 2b from the semiconductor laser 1 side is outputted to the objective lens 4 side from the liquid crystal diffraction optical element 2b with high efficiency. For this reason, the amount of an outputted light from the objective lens 4 is large, and therefore a high optical output can be obtained upon recording.

On the other hand, upon reproduction of information from the disk 5, the effective value of an AC voltage applied to the liquid crystal polymer layer 9c is set to 5 V, and that of the AC voltage applied to the liquid crystal polymer layer 9d is set to 0 V. In this case, the emitted light from the semiconductor laser 1 is incident on the liquid crystal diffraction optical element 2b, and without depending on the polarization state of the light, approximately 10% of the light transmits it as the 0-th order light to travel to the disk 5. Also, the reflected light from the disk 5 is incident on the liquid crystal diffraction optical element 2b, and without depending on the polarization state of the reflected light, as the ±1st order diffracted light, approximately 36.5% of the reflected light is diffracted to travel to the optical detectors 6a and 6b, respectively. As a result, the light incident on the liquid crystal diffraction optical element 2b from the objective lens 4 side is outputted to the optical detectors 6a and 6b sides from the liquid crystal diffraction optical element 2b with high efficiency without depending on the polarization state of the light. For this reason, if a protection layer of the disk 5 has no birefringence, the total amount of received lights in the optical detectors 6a and 6b upon reproduction is large, and therefore a high signal-to-noise ratio can be obtained upon reproduction. Also, even if the protection layer of the disk 5 has in-plane or vertical birefringence, the total amount of the received light in the optical detectors 6a and 6b upon reproduction is unchanged, and therefore the signal-to-noise ratio obtained upon reproduction is unchanged. That is, even if the protection layer of the disk 5 has some birefringence, a high signal-to-noise ratio can be obtained upon reproduction.

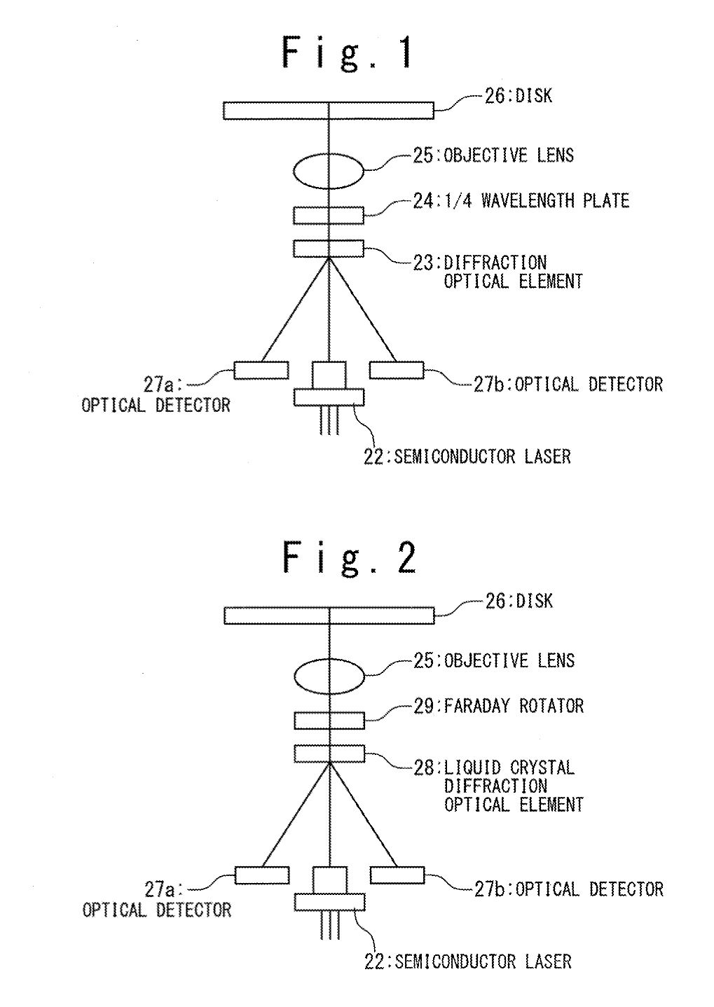

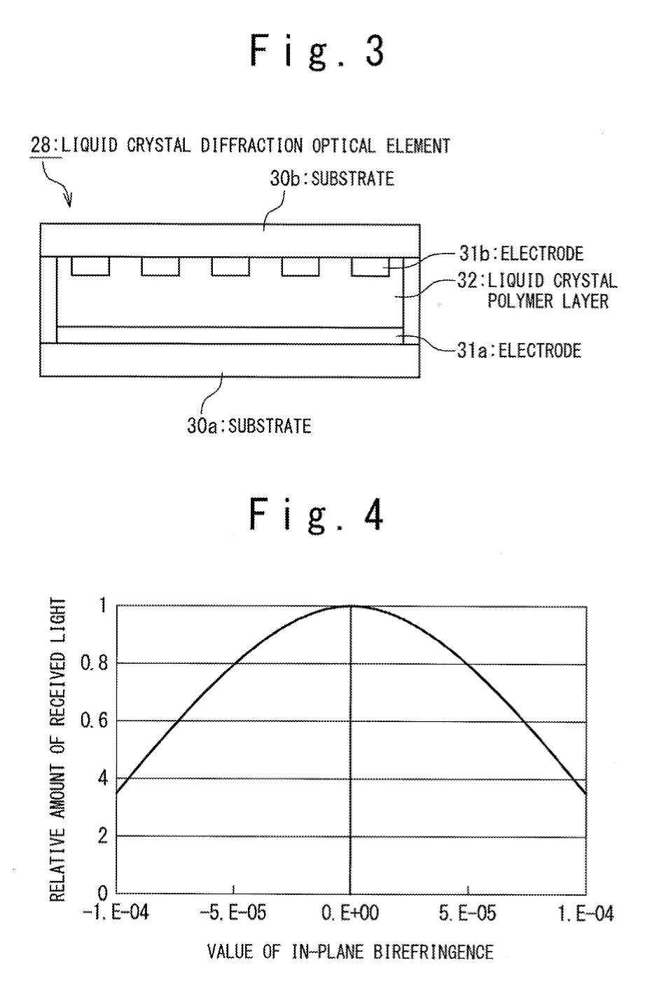

An optical head device according to a third embodiment of the present invention is one in which the liquid crystal diffraction optical element 2a in the first embodiment is replaced by a liquid crystal diffraction optical element 2c, and a configuration of the third embodiment is the same as that illustrated in FIG. 1

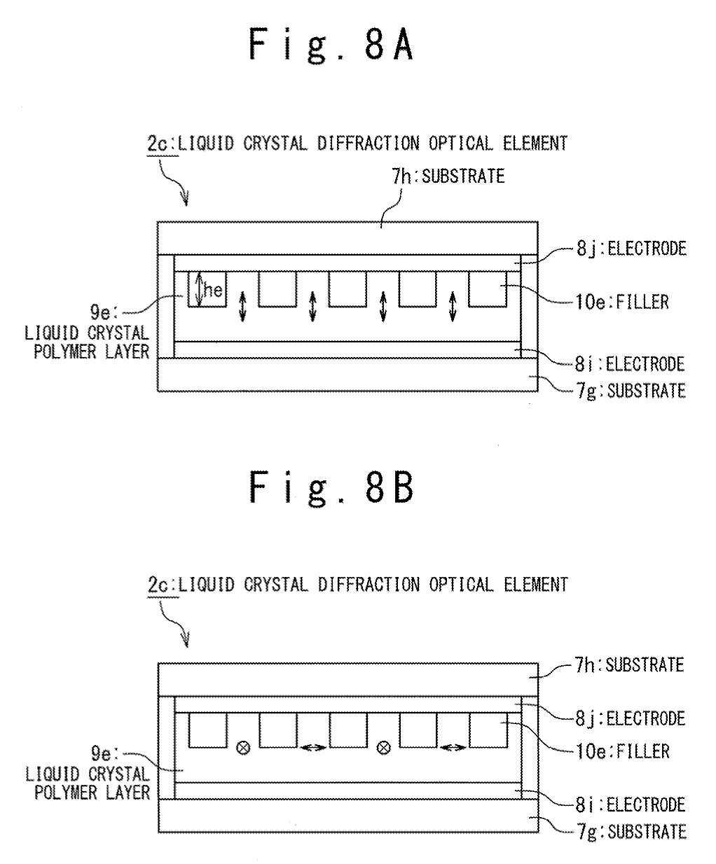

FIGS. 8A and 8B are cross-sectional views of the liquid crystal diffraction optical element 2c. The liquid crystal diffraction optical element 2c has a configuration in which a liquid crystal polymer layer 9e and a filler 10e are sandwiched between substrates 7g and 7h. On a surface of the substrate 7g on the liquid crystal polymer layer 9e side and a surface of the substrate 7h on the liquid crystal polymer layer 9e side, electrodes 8i and 8j for applying an AC voltage to the liquid crystal polymer layer 9e are formed, respectively. The electrodes 8i and 8j are both entire surface electrodes. Arrows in the diagrams indicate the longer direction of liquid crystal polymers in the liquid crystal polymer layer 9e. The liquid crystal polymer layer 9e has uniaxial refractive index anisotropy in which the direction of the optical axis corresponds to the longer direction of the liquid crystal polymers. Assuming that the refractive index for a polarization component (extraordinary light component) in the direction parallel to the longer direction of the liquid crystal polymers is denoted by ne, and that for a polarization component in the direction vertical to the longer direction is denoted by no, ne is large as compared with no. Also, a refractive index of the filler 10e is denoted by nf. The filler 10e forms a diffractive grating having a rectangular cross-sectional shape of which widths of a line region and space region are the same. We here denote a depth of the diffraction grating formed by the filler 10e as he.

In a case where the effective value of an AC voltage applied to the liquid crystal polymer layer 9e is set to 5 V, the longer direction of the liquid crystal polymers in the liquid crystal polymer layer 9e corresponds to the direction parallel to the optical axis of incident light as illustrated in FIG. 8A. Accordingly, without depending on the polarization state of the incident light, the refractive index of the liquid crystal polymer layer 9e for the incident light becomes no. For this reason, if no≠nf, the diffraction grating formed by the filler 10e has a diffractive action. On the other hand, in a case where the effective value of an AC voltage applied to the liquid crystal polymer layer 9e is set to 0 V, the longer direction of the liquid crystal polymers in the liquid crystal polymer layer 9e corresponds to the direction that is vertical to the optical axis of the incident light and random for each of the liquid crystal polymers as illustrated in FIG. 8B.

Accordingly, without depending on the polarization state of the incident light, the refractive index of the liquid crystal polymer layer 9e for the incident light becomes [(2no²+ne²)/3]^{1/2}. For this reason, if, given that nr=[(2no²+ne²)/3]^{1/2}, nr≠nf, the diffraction grating formed by the filler 10e has the diffractive action. Given here that no=1.5, ne=1.7, and nf=1.476, the value he can be determined so as to meet he=0.102λ/(no−nf)=0.398λ/(nr−nf) (λ is the wavelength of the incident light).

In a case where the effective value of an AC voltage applied to the liquid crystal polymer layer 9e is set to 5V, if the value he is determined as above, the transmittance of 0-th order light, and each of diffraction efficiencies of ±1st order diffracted light in the diffraction grating formed by the filler 10e become 90% and 4.1%, respectively. On the other hand, in a case where the effective value of an AC voltage applied to the liquid crystal polymer layer 9e is set to 0 V, if the value he is determined as above, the transmittance of the 0-th order light and each of the diffraction efficiencies of the ±1st order diffracted light in the diffraction grating formed by the filler 10e become 10% and 36.5%, respectively.

Upon recording of information on the disk 5, the effective value of an AC voltage applied to the liquid crystal polymer layer 9e is set to 5 V. In this case, the emitted light from the semiconductor laser 1 is incident on the liquid crystal diffraction optical element 2c, and without depending on the polarization state of the light, approximately 90% of the light transmits it as the 0-th order light to travel to the disk 5. Also, the reflected light from the disk 5 is incident on the liquid crystal diffraction optical element 2c, and without depending on the polarization state of the reflected light, as the ±1st order diffracted light, approximately 4.1% of the reflected light is diffracted to travel to the optical detectors 6a and 6b. As a result, the light incident on the liquid crystal diffraction optical element 2c from, the semiconductor laser 1 side is outputted to the objective lens 4 side from the liquid crystal diffraction optical element 2c with high efficiency. For this reason, the amount of outputted light from the objective lens 4 upon recording is large, and therefore a high optical output can be obtained upon recording.

On the other hand, upon reproduction of information from the disk 5, the effective value of an AC voltage applied to the liquid crystal polymer layer 9e is set to 0 V. In this case, the emitted light from the semiconductor laser 1 is incident on the liquid crystal diffraction optical element 2c, and without depending on the polarization state of the light, approximately 10% of the light transmits it as the 0-th order light to travel to the disk 5. Also, the reflected light from the disk 5 is incident on the liquid crystal diffraction optical element 2c, and without depending on the polarization state of the reflected light, as the ±1st order diffracted light, approximately 36.5% of the reflected light is diffracted to travel to the optical detectors 6a and 6b. As a result, the light incident on the liquid crystal diffraction optical element 2c from the objective lens 4 side is outputted to the optical detectors 6a and 6b sides from the liquid crystal diffraction optical element 2c with high efficiency without depending on the polarization state of the light. For this reason, if the protection layer of the disk has no birefringence, the total amount of received light in the optical detectors 6a and 6b upon reproduction is large, and therefore a high signal-to-noise ratio can be obtained upon reproduction. Also, even if the protection layer of the disk has in-plane or vertical birefringence, the total amount of the received light in the optical detectors 6a and 6b upon reproduction is unchanged, and therefore the signal-to-noise ration obtained upon reproduction is unchanged. That is, even if the protection layer of the disk 5 has any birefringence, a high signal-to-noise ratio can be obtained upon reproduction.

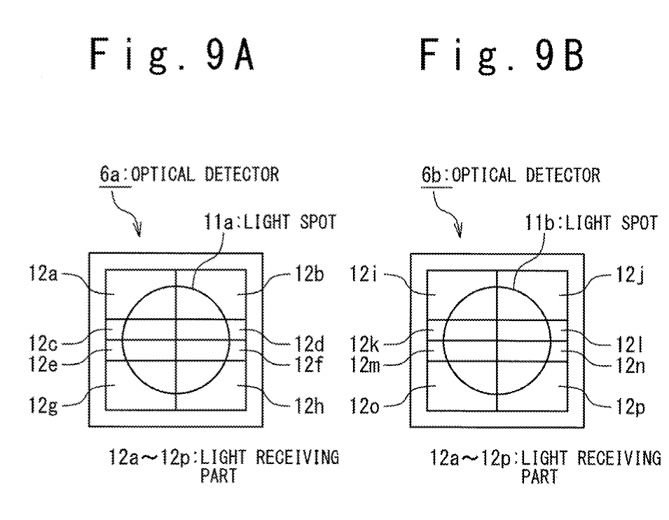

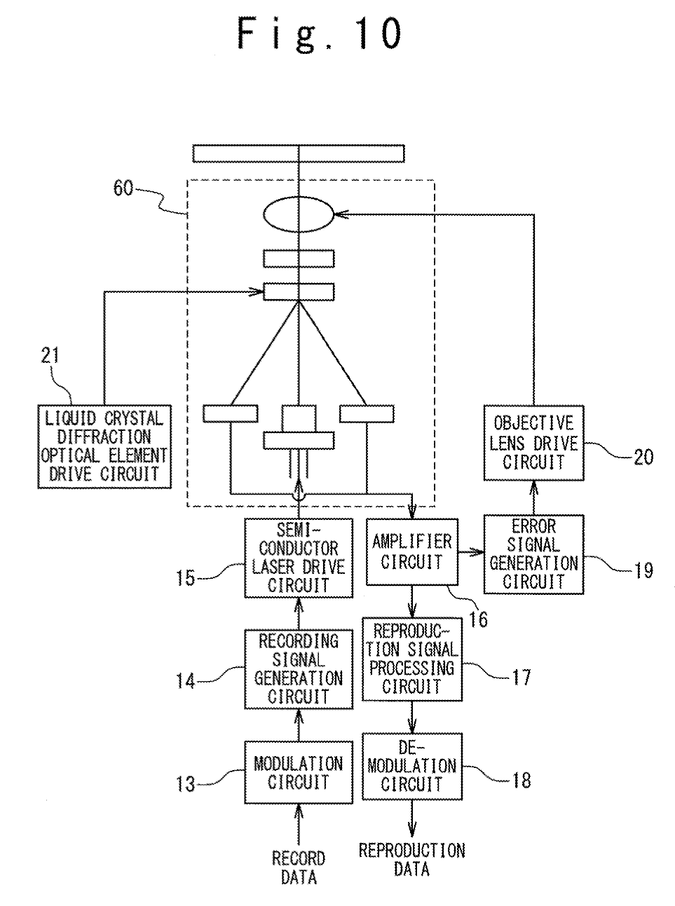

FIGS. 9A and 9B illustrate light receiving parts of the optical detectors 6a and 6b, and optical spots formed on the light receiving parts. Each of the light receiving parts of the optical detectors 6a and 6b is divided by one linear line parallel to the track of the disk 5 and three linear lines vertical to the track of the disk 5. Accordingly, as illustrated in FIG. 9A, the optical detector 6a includes eight light receiving parts, i.e., receiving parts 12a to 12h. The optical detector 6b includes, as illustrated in FIG. 9B, eight receiving parts, i.e., receiving parts 12i to 12p.

Each of the liquid crystal diffraction optical elements 2a to 2c functions as a concave lens for the −1st order diffracted light, and as a convex lens for the +1st order diffracted light. The optical detectors 6a and 6b respectively receive the −1st order diffracted light and +1st order diffracted light from the liquid crystal diffracted optical element 2a to 2c in the return path. Positions of the light receiving parts of the optical detectors 6a and 6b in the optical axis direction are intermediates from focusing points of −1st order diffracted light of the liquid crystal diffraction optical element 2a to 2c to focusing points of the +1st order diffracted light of the liquid crystal diffraction optical element 2a to 2c in the return paths, in a case where the focusing point of an outputted light from the objective lens 4 in the outward path is present on the recording surface of the disk 5. In this case, the optical spot 11a formed on the light receiving part of the optical detector 6a by the −1st order diffracted light from the liquid crystal diffraction optical elements 2a to 2c in the return path, and the optical spot 11b formed on the light receiving part of the optical detector 6b by the +1st order diffracted light from the liquid crystal diffraction optical elements 2a to 2c in the return path are almost same in size.

Assuming that outputs from the light receiving parts 12a to 12p are respectively denoted by V12a to V12p, a focus error signal, a track error signal, and a reproduction signal that is a mark/space signal recorded on the disk 5 are detected on the basis of V12a to V12p as described below. The focus error signal is obtained from calculation of (V12a+V12b+V12g+V12h+V12k+V12l+V12m+V12n)−(V12c+V12d+V12e+V12f+V12i+V12j+V12o+V12p) on the basis of a known spot size method. The track error signal is obtained from calculation of (V12a+V12c+V12e+V12g+V12j+V12l+V12n+V12p)−(V12b+V12d+V12f+V12h+V12i+V12k+V12m+V12o) on the basis of a known push-pull method upon recording of information on the disk 5, and upon reproduction of information from the disk 5, obtained from the phase difference between (V12a+V12c+V12f+V12h+V12i+V12k+V12n+V12p) and (V12b+V12d+V12e+V12g+V12j+V12l+V12m+V12o) on the basis of a known phase difference method. The reproduction signal is obtained from calculation of (V12a+V12b+V12c+V12d+V12e+V12f+V12g+V12h+V12i+V12j+V12k+V12l+V12m+V12n+V12o+V12p).

FIG. 10 illustrates a configuration of an optical information recording/reproducing device according to a fourth embodiment of the present invention. In the present embodiment, the optical information recording/reproducing device includes the optical head device 60 illustrated in FIG. 5, a modulation circuit 13, a recording signal generation circuit 14, a semiconductor laser drive circuit 15, an amplifier circuit 16, a reproduction signal processing circuit 17, a demodulation circuit 18, an error signal generation circuit 19, an objective lens drive circuit 20, and a liquid crystal diffraction optical element drive circuit 21.

The modulation circuit 13 modulates data to be recorded on the disk 5, according to a modulation rule. The recording signal generation circuit 14 generates, on the basis of a signal modulated in the modulation circuit 13, a recording signal for driving the semiconductor laser 1 according to a recording strategy. The semiconductor laser drive circuit 15 supplies, on the basis of the recording signal generated in the recording signal generating circuit 14, a current depending on the recording signal to the semiconductor laser 1 to drive the semiconductor laser 1. Based on this, information is recorded on the disk 5.

The amplifier circuit 16 amplifies an output from each of the light receiving parts of the optical detectors 6a and 6b. The reproduction signal processing circuit 17 performs generation, waveform equalization, and binarization of a reproduction signal on the basis of signals amplified in the amplifier circuit 16. The demodulation circuit 18 demodulates, according to a demodulation rule, the signal binarized in the reproduction signal processing circuit 17. Based on this, information from the disk 5 is reproduced.

The error signal generation circuit 19 generates the focus error signal and the track error signal on the basis of the signals amplified in the amplifier circuit 16. The objective lens drive circuit 20 supplies, a current depending on the error signals to an unshown actuator for driving the objective lens 4 to drive the objective lens 4 on the basis of the error signals generated in the error signal generation circuit 19. Further, the optical system excluding the disk 5 is driven in the radius direction of the disk 5 by an unshown positioner. The disk 5 is rotationally driven by an unshown spindle. Based on these, servos of a focus, a track, a positioner, and a spindle are performed.

The liquid crystal diffraction optical element drive circuit 21 applies AC voltages to the electrodes 8a to 8d of the liquid crystal diffraction optical element 2a to drive the liquid crystal diffraction optical element 2a serving as the light separation part. That is, upon recording of information on the disk 5, the liquid crystal diffraction optical element drive circuit 21 drives the liquid crystal diffraction optical element 2a such that the light incident on the liquid crystal diffraction optical element 2a from the semiconductor laser 1 side is outputted to the objective lens 4 side from the liquid crystal diffraction optical element 2a with high efficiency. Upon reproduction of information from the disk 5, the liquid crystal diffraction optical element drive circuit 21 drives the liquid crystal diffraction optical element 2a such that the light incident on the liquid crystal diffraction optical element 2a from the objective lens 4 side is outputted to the optical detectors 6a and 6b from the liquid crystal diffraction optical element 2a with high efficiency without depending on the polarization state of the light. Based on these, characteristics of the light separation part are switched.

The circuits from the modulation circuit 13 to the semiconductor laser drive circuit 15, which are related to information recording, the circuits from the amplifier circuit 16 to the demodulation circuit 18, which are related to information reproduction, the circuits from the amplifier circuit 16 to the objective lens drive circuit 20, which are related to the servos, the circuit relating to the switching of the characteristics of the light separation part, namely the liquid crystal diffraction optical element drive circuit 21, are controlled by an unshown controller. From the controller to the liquid crystal diffraction optical element drive circuit 21, a Low level recording gate signal is transmitted upon recording of information on the disk 5, whereas a High level recording gate signal is transmitted upon reproduction of information from the disk 5. The liquid crystal diffraction optical element drive circuit 21 drives the liquid crystal diffraction optical element 2a according to the recording gate signals.

The optical information recording/reproducing device may include the optical head device 60, the modulation circuit 13, the recording signal generation circuit 14, the semiconductor laser drive circuit 15, the amplifier circuit 16, the reproduction signal processing circuit 17, the demodulation circuit 18, the error signal generation circuit 19, the objective lens drive circuit 20, and the liquid crystal diffraction optical element drive circuit 21 described in the second or third embodiment.

According to the present invention, there can be provide an optical head device capable of obtaining a high optical output upon recording of information on an optical recording medium, and also upon reproduction of information from an optical recording medium, obtaining a high signal-to-noise ratio even if a protection layer of the optical recording medium has some birefringence, and an optical information recording/reproducing device and an optical information recording/reproducing method using the optical head device. This is because characteristics of a light separation part is configured such that, upon recording, light incident on the light separation part from a light source side is outputted to an objective lens side from the light separation part with high efficiency, and also upon reproduction, light incident on the light separation part from the objective lens side is outputted to the optical detector side from the light separation part with high efficiency without substantially depending on the polarization state of the light. As above, the present invention has been described referring to the embodiments; however, the present invention is not limited to any of the above-described embodiments. Various modifications that one skilled in the art can appreciate can be made to the configuration and details of the present invention within the scope of the present invention.

What is claimed is:

1. An optical head device comprising:
a light focus part configured to focus an emission light emitted from a light source on an optical recording medium on which information is recorded and from which information is reproduced based on a difference in a reflectivity between a mark region and a space region;
an optical detection part configured to receive a reflection light reflected by the optical recording medium;
a light separation part configured to separate the emission light and the reflection light, and
assuming that a ratio of an amount of light of a light emitted from the light separation part toward the light focus part to an amount of light of a light incident on the light separation part from the light source is a ratio of an outward path, and a ratio of an amount of light of a light emitted from the light separation part toward the optical detection part to an amount of light of a light incident on the light separation part from the light focus part is a ratio of a return path,
the light separation part is configured to be able to switch its characteristic between a first state in which the ratio of the outward path is a first value, and a second state in which the ratio of the outward path is a second value smaller than the first value, and
when the characteristic of the light separation part is at the second state, the ratio of the return path is determined substantially independently to a polarization state of a light incident on the light separation part from the light focus part.

2. The optical head device according to claim 1, wherein the light separation part comprises a diffraction grating which includes:
a liquid crystal polymer layer; and
an electrode configured to apply an alternating current on the liquid crystal polymer layer.

3. The optical head device according to claim 2, wherein the liquid crystal polymer layer includes liquid crystal molecules which is oriented in a direction parallel to an optical axis of an incident light incident on the liquid crystal polymer layer at the first state, and is oriented at random in a direction vertical to an optical axis of an incident light incident on the liquid crystal polymer layer at the second state.

4. An optical information recording/reproducing device comprising:
an optical head device according to claim 1; and
a drive circuit configured to drive the light separation part to switch the characteristic of the light separation part between the first state and the second state in response to an operation state.

5. The optical information recording/reproducing device according to claim 4, wherein the drive circuit is configured to: drive the light separation part to set the characteristic to the first state when information is recorded on the optical recording medium; and drive the light separation part to set the characteristic to the second state when information is reproduced from the optical recording medium.

6. An optical information recording/reproducing method for recording and reproducing information by an optical information recording/reproducing device comprising:
an optical head device according to claim 1; and
a drive circuit configured to drive the light separation part,
wherein the optical information recording/reproducing method for recording and reproducing information comprises:
driving the light separation part by the drive circuit to set the characteristic of the light separation part to the first state when information is recorded on the optical recording medium; and
driving the light separation part by the drive circuit to set the characteristic of the light separation part to the second state when information is reproduced from the optical recording medium.

7. An optical information recording/reproducing method for recording and reproducing information comprising:
focusing an emission light emitted from a light source on an optical recording medium on which information is recorded and from which information is reproduced based on a difference in a reflectivity between a mark region and a space region by a light focus part;
receiving a reflection light reflected by the optical recording medium by an optical detection part;
separating the emission light and the reflection light by a light separation part, and
assuming that a ratio of an amount of light of a light emitted from the light separation part toward the light focus part to an amount of light of a light incident on the light separation part from the light source is a ratio of an outward path, and a ratio of an amount of light of a light emitted from the light separation part toward the optical detection part to an amount of light of a light incident on the light separation part from the light focus part is a ratio of a return path,
the separating comprises:
separating the emission light and the reflection light by setting the ratio of the outward path to a first value when information is recorded on the optical recording medium; and
separating the emission light and the reflection light by determining the ratio of the return path substantially independently to a polarization state of a light incident on the light separation part from the light focus part by setting the ratio of the outward path to a second value smaller than the first value when information is reproduced from the optical recording medium.
